(19) United States
(12) Patent Application Publication
(10) Pub. No.: US 2012/0070282 A1
(43) Pub. Date: Mar. 22, 2012

(54) High torque vertical axis windmill

(76) Inventors: Ghulam Murtaza Khan, SR., Greenfield, WI (US); Ghulam Ahmad Khan, JR., Greenfield, WI (US)

(21) Appl. No.: 13/199,687

(22) Filed: Sep. 8, 2011

Related U.S. Application Data
(60) Provisional application No. 61/403,512, filed on Sep. 17, 2010.

(51) Int. Cl. F03D 3/06; F03D 7/06

(52) U.S. Cl. 416/3; 416/87; 416/23

(57) ABSTRACT

A high torque vertical axis windmill that has blades with curved parts secured together. The second part of each blade is movable to deploy the maximum surface of the blade to the wind for maximum torque during a portion of the cycle of the blades. The second part of each blade is movable to a second position to deploy the minimum surface of the blade to the wind for minimum drag during another portion of the cycle of the blades.

Applicants claim priority of Provisional application Ser. No. 61/403,512, filed Sep. 17, 2010.

### BACKGROUND OF THE INVENTION

This invention relates, in general, to devices for capturing the power of the wind, and, in particular, to devices wherein drag on the blades of the windmill is reduced.

### DESCRIPTION OF THE PRIOR ART

In the prior art various types of wind capturing devices have been proposed. For example, U.S. Pat. No. 4,468,169 to Williams discloses a vertical windmill with a plurality of vanes and each vane has a vane stop for limiting the rotation of the vanes.

U.S. Pat. No. 7,083,382 to Ursua discloses a windmill having a shaft with blades attached and the blades are moveable from a first position to a second position and there is less drag when the blades are in the second position.

U.S. Pat. No. 5,193,978 to Gutierrez discloses a windmill with an articulated vane and a rear deflector. A control arm maintains the deflector in parallel orientation thus cambering the blade when it pitches.

Published application 2010/0054936 to Sneeringer discloses a vertical axis windmill with a plurality of blades having a high lift device.

Published application 2004/0156723 to Tsipov discloses a vertical axis windmill with gate elements and vanes which are designed so the wind turns the gate elements so as to open corresponding ones of the openings.

### SUMMARY OF THE INVENTION

The present invention is directed to a high torque vertical axis windmill that has blades with curved parts secured together. The second part of each blade is movable to deploy the maximum surface of the blade to the wind for maximum torque during a portion of the cycle of the blades. The second part of each blade is movable to a second position to deploy the minimum surface of the blade to the wind for minimum drag during another portion of the cycle of the blades.

It is an object of the present invention to provide a new and improved device for capturing the energy of the wind.

It is an object of the present invention to provide a new and improved device for capturing the energy of the wind which increases the surface area of the windmill blades to increase the torque of the windmill.

It is an object of the present invention to provide a new and improved device for capturing the energy of the wind which decreases the surface area of the windmill blades to decrease the drag of the windmill blades.

These and other objects and advantages of the present invention will be fully apparent from the following description, when taken in connection with the annexed drawings.

### BRIEF DESCRIPTION OF THE DRAWINGS

FIG. 1 is a perspective view of the present invention.

FIG. 2 is a perspective view of another aspect of the present invention.

FIG. 3 is a partial view of the wheels in a track of the present invention.

FIG. 4 is a partial view of the track of the present invention.

FIGS. 5A and 5B are partial views of the resilient blade support of the present invention as it moves a blade from a first position to a second position.

FIG. 6 is a partial view of a resilient blade support of the present invention holding the blade in the second position.

FIG. 7 is a partial view of a resilient blade support of the present invention.

FIGS. 8A and 8B show a partial view of another resilient blade support of the present invention.

FIGS. 9A and 9B show the resilient blade support of FIGS. 8A and 8B separate from and attached to a blade.

FIG. 10 is a partial view of the present invention showing four blades as seen from the top of the windmill.

FIG. 11 is a perspective view of another embodiment of the present invention.

FIG. 12 is a partial top view of another embodiment of a resilient blade support of the present invention.

FIG. 13 is a side view of another embodiment of a resilient blade support of the present invention.

FIG. 14 is a partial top view of another embodiment of resilient blade support of the present invention.

FIG. 15 is a partial view of another wheel and track of the present invention.

### DESCRIPTION OF THE PREFERRED EMBODIMENT

The preferred embodiment herein described is not intended to be exhaustive or to limit the invention to the precise form disclosed. It is chosen and described to best explain the invention so that others, skilled in the art to which the invention pertains, might utilize its teachings.

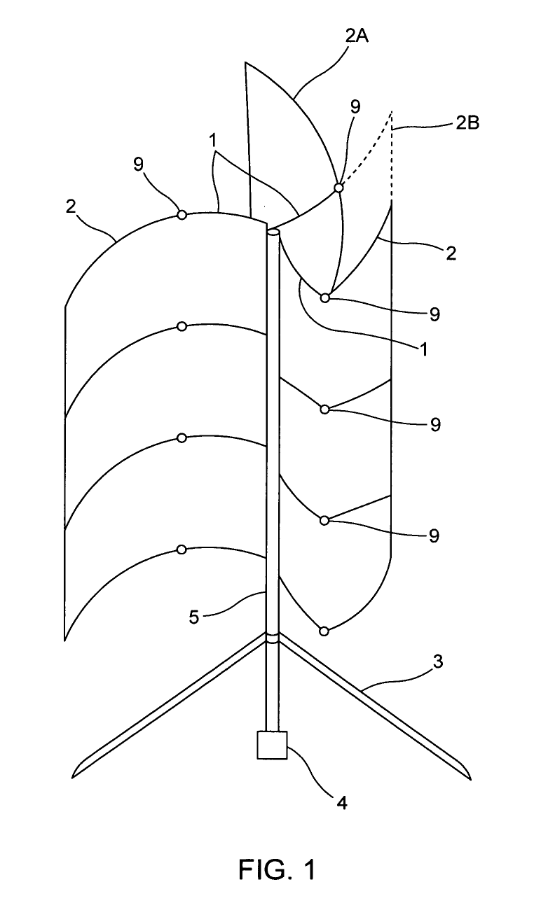

Referring now to the drawings in greater detail, FIG. 1 shows a perspective view of the windmill of the present invention. The windmill has a plurality of blades 1, 2 pivotally attached to a central support shaft 5 in any conventional manner. The windmill can have and additional supporting means 3 necessary to support the windmill. In addition, the shaft 5 will be connected to any conventional means 4 which will store the energy of the windmill. The windmill can also be connected to any conventional energy means such as, but not limited to, air/gas/hydraulic compressors, pumps, conveyors flour grinding mills and/or electrical generators. Also, it should be noted that three blades 1, 2 are shown in FIG. 1, however, the present invention is not limited to any particular number. The present invention could use less than or more than the number of blades shown in the drawings.

As shown in FIG. 1, each of the blades is made up of two curved blade portions connected together at a joint 9. The first blade portion 1 is smaller than the second blade part 2 and is firmly attached to the shaft 5 by any conventional means. The first blade portion 1 is pivotably secured to the second blade part 2 at a hinge 9, which is shown in more detail in FIGS. 5-9 and FIGS. 12-14.

As the wind turns the windmill in a clockwise direction in FIG. 1, the blades 1, 2, shown at the far left, will be struck by the wind and will produce a force that can be transmitted through the shaft 5 to the storage means 4. However, as the blades continue to turn and the wind hits the next adjacent blade the first blade transfers from a means for collecting a maximum amount of wind force to producing a drag, since the surface area of the blades (once the force of the wind is partially blocked by the succeeding blade) causes drag on the blades.

As shown in FIG. 1, the present invention allows the blade portion 2 to move with respect to blade portion 1 from a first position designated by dotted lines as 2B to a second position designated by solid lines as 2A. When the blade pivots about hinge 9 from the first to the second position 2A, the blade portion 2 will have less surface area exposed to present a drag on the blade as shown in FIG. 5. Therefore, the windmill will operate in a more efficient manner.

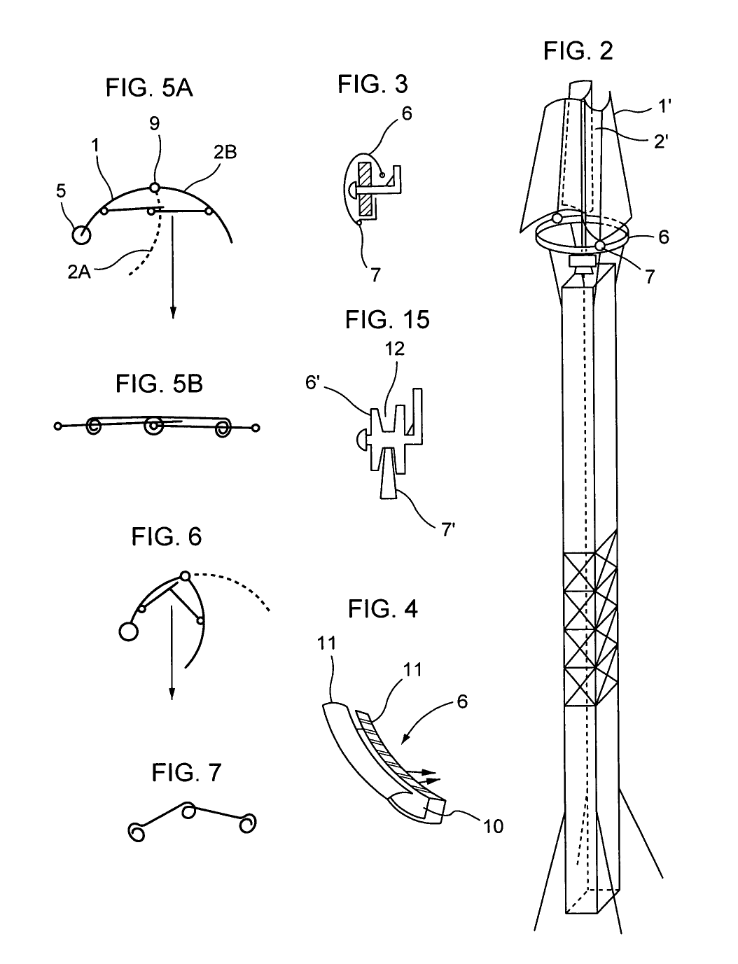

FIG. 2 shows a modified windmill which has first and second blade portions 1′, 2′, which are similar to the blade portions 1, 2 in FIG. 1. The windmill is supported on a stand 8 which will be strong enough to support the windmill during operation. In FIG. 2, the blades are supported on wheels 7 which run in a track 6, as shown in FIG. 3. Since the track is curved over the wheels 7 the wheels will be protected from the elements and they will not be bothered by snow or ice. The wheels will have high quality bearings or bushings to minimize frictional losses and increase the efficiency of the windmill. The track of FIG. 3 is shown in FIG. 4 in more detail. The top 11 of the track covers most of the floor 10 of the track, which the wheels ride on, to protect this portion of the track. In addition, the floor will have a plurality of drainage holes 11 to move water and snow away from the track.

FIGS. 5A and 5B shows the blade 1, 2 in two positions. In FIG. 5A (position 2) the blade has passed the region where the wind is pressing against the blade, that is the blade has rotated into the position that the wind is now pressing directly on an adjacent blade and the blade shown in FIG. 5A will have to be pivoted into a partially compressed position to present less surface area to the wind. The blade is shown in a partially compressed position 2B in solid lines, and shown in a fully compressed position in dotted lines 2A. FIG. 5B (position 1) shows the blade in the fully open position with the wind pressing directly on the blade. The blade is normally held in the FIG. 5A position by a resilient device such as leaf spring 12. The power of the wind (the direction of the wind is shown in FIG. 5B by the arrows) forces the blade to pivot into a fully extended position (FIG. 5B) against the force on the resilient device 12. Once the power of the wind is no longer fully engaging a blade, the force of the spring compresses the blade into a closed position, as shown in FIG. 6. FIG. 7 shows the leaf spring 12 separate from the blade.

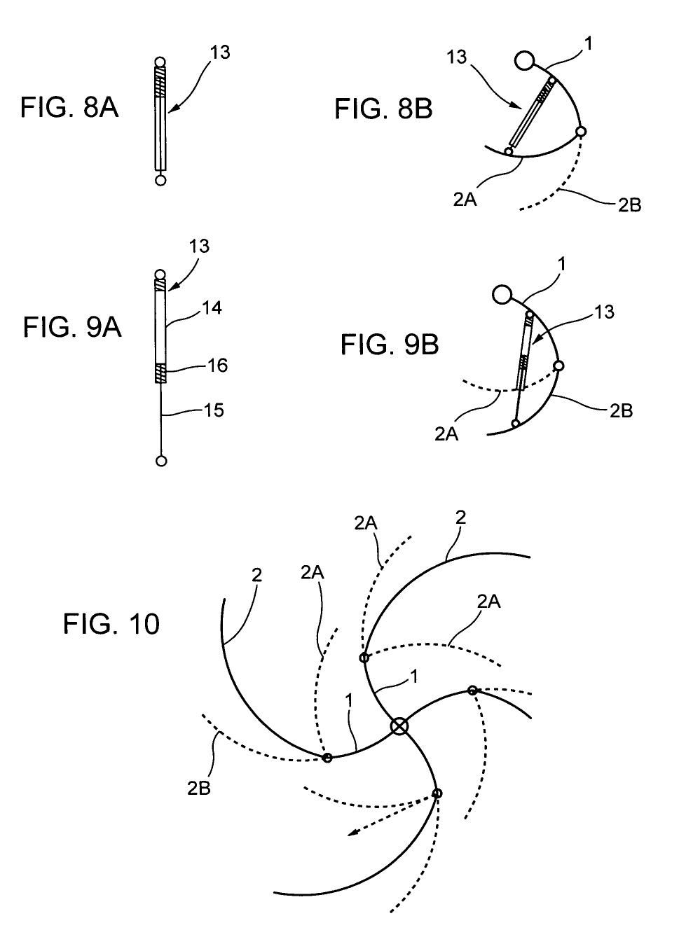

FIG. 8A shows a different resilient device 13 that can be used with the present invention. FIG. 8B shows the resilient device 13 attached to a blade. FIG. 9A shows the resilient blade device 13 in more detail. The device comprises a hollow tube 14 in which a rod or tube 15 moves back and forth. A compression spring 16 is positioned in the tube 14 so the spring will be compressed as the rod 16 moves out of the tube as shown in FIG. 9a and the spring will expand as the rod moves into the tube as shown in FIG. 8A. FIG. 9B shows the resilient device 13 attached to a blade.

FIG. 10 shows a plurality of blades as seen from above with the blade portion 2 in various positions 2A, 2B as it moves from a fully extended position to a fully compressed position.

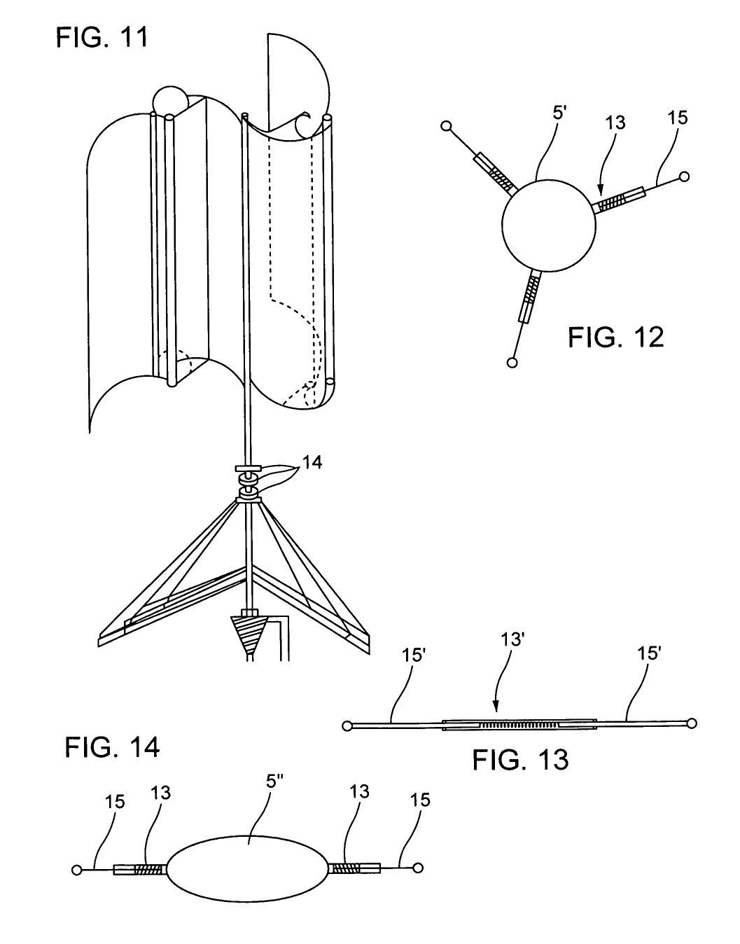

FIG. 11 shows an another embodiment of the present invention that uses magnetic levitation instead of the wheel and track mechanisms of FIGS. 3 and 15. Two permanent magnets 14 are positioned around the mast in place of the wheels and tracks. The magnets are positioned at the rotational junction of the mast and its support in any conventional manner. The magnets should be positioned so the same poles are adjacent each other to provide magnetic levitation to allow the windmill to rotate without friction, or with as little friction as possible.

FIGS. 12-14 show various embodiments of springs that can be used with the present invention. In FIG. 12 a mast 5′ has three spring mechanisms 13, 15 connected in the same manner as the embodiments of FIGS. 9A and 9B and works in the same manner. The FIG. 13 embodiment uses a single tube 13′ and two rods 15′ enter the tube 13′ from opposite ends. In all other respects the spring mechanism of FIG. 13 operates in the same manner as the embodiments of FIGS. 9A and 9B. In the FIG. 14 embodiment a pair of tubes 13 with rods 15 are positioned on opposite sides of an elliptical mast 5″, and the spring mechanism of FIG. 14 operates in the same manner as the embodiments of FIGS. 9A and 9B.

Another version of the track and wheels is shown in FIG. 15. In this case the wheel 6′ is a two part wheel with a slot 12 extending around the circumference of the wheel. The track is a rail 7′ and this embodiment operates similar to a mono-rail.

Although the High Torque Vertical Axis Windmill and the method of using the same according to the present invention has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A windmill comprising
shaft means for supporting at least one blade,
at least one blade,
each of said at least one blade having a first portion and a second portion,
said first portion and said second portion having a first end and a second end,
means for securing said first end of said first portion to said shaft means,
means for securing said first end of said second portion to said second end of said first portion,
said second portion being movable, with respect to said first portion, from a first position to a second position, and
when in said first position said second end of said second portion is remote from said shaft means, and
when in said second position said second end of said second portion is adjacent said shaft means.

2. The windmill as claimed in claim 1, wherein said shaft is vertically oriented.

3. The windmill as claimed in claim 1, wherein said second portion has mechanical means for holding said second portion in said second position.

4. The windmill as claimed in claim 3, wherein said means for holding said second portion in said second position comprises a resilient device.

5. The windmill as claimed in claim 4, wherein said resilient device is a leaf spring.

6. The windmill as claimed in claim 4, wherein said resilient device comprises a hollow tube, and
a rod is secured in said hollow tube to move from an inner position to an outer position, and
resilient means for moving said rod from said inner position to said outer position.

7. The windmill as claimed in claim 4, wherein said resilient device comprises a hollow tube, and
a pair of rods are secured in said hollow tube to move from an inner position to an outer position, and
resilient means for moving said rods from said inner position to said outer position.

8. The windmill as claimed in claim 1, wherein said at least one blade has an upper side and a lower side extending between said first end and said second end, and
means connected to said lower side for supporting said at least one blade.

9. The windmill as claimed in claim 8, wherein said means for supporting said at least one blade comprises a track,
wheels attached to said lower side of said at least one blade, and
said wheels engage said track to support said at least one blade.

10. The windmill as claimed in claim 9, wherein said track has a portion that overhangs a top of said wheels.

11. The windmill as claimed in claim 9, wherein said track has a floor and said wheels engage said floor,
said floor has at least one drainage hole.

12. The windmill as claimed in claim 8, wherein said means for supporting said at least one blade comprises a pair of magnets.

13. The windmill as claimed in claim 8, wherein said magnets are attached to said shaft in position so the same poles of the magnets are adjacent each other.

14. A high torque vertical axis windmill comprising at least one blade with a first part and a second part,
means for making said second part of said at least one blade movable for deploying a maximum surface of said at least one blade to the wind for maximum torque during a portion of a cycle of said at least one blade,
means for allowing said second part of said at least one blade to move to a second position to deploy the minimum surface of the blade to the wind for minimum drag during another portion of a cycle of said at least one blade.

15. The windmill as claimed in claim 14, wherein said second part has mechanical means for holding said second part in said second position.

16. The windmill as claimed in claim 15, wherein said means for holding said second part in said second position comprises a resilient device.

17. The windmill as claimed in claim 16, wherein said resilient device is a leaf spring.

18. The windmill as claimed in claim 16, wherein said resilient device comprises a hollow tube, and
a rod is secured in said hollow tube to move from an inner position to an outer position, and
resilient means for moving said rod from said inner position to said outer position.

19. The windmill as claimed in claim 16, wherein said resilient device comprises a hollow tube, and
a pair of rods are secured in said hollow tube to move from an inner position to an outer position, and
resilient means for moving said rods from said inner position to said outer position.

20. The windmill as claimed in claim 14, wherein said at least one blade has an upper side and a lower side, and
means connected to said lower side for supporting said at least one blade.
